(19) United States
(12) Patent Application Publication
(10) Pub. No.: US 2008/0303745 A1
(43) Pub. Date: Dec. 11, 2008

(54) Register authorization system and its method of downloading extended display identification data

(75) Inventors: Shih-Hua Tseng, Taipei (TW); Pai-Tung Chu, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/003,536

(22) Filed: Dec. 28, 2007

(30) Foreign Application Priority Data
Jun. 8, 2007 (TW) 096120887

(51) Int. Cl. G09G 5/00

(52) U.S. Cl. 345/1.1

(57) ABSTRACT

The present invention provides a register authorization system and its method of downloading extended display identification data (EDID), comprising: a parent system unit, stored with a plurality of EDID, and used for accepting a logon and registration request; and a sub system unit, coupled to the parent system unit, after the parent system unit accepts the logon and registration request, and a data transmission procedure between the sub system unit and the parent system unit is authenticated and protected under a specific algorithm, the sub system unit then obtains an authentication and authorization instruction from the parent system unit to execute an EDID download program. Therefore, the objective of the present invention is to provide a register authorization system of downloading extended display identification data, so as to execute the EDID download program based on its registration and authorization function.

### BACKGROUND OF THE INVENTION

1. Field of the Invention

The present invention relates to a register authorization system, and more particularly, to a register authorization system and its method applicable of downloading extended display identification data.

2. Description of Related Art

With the popularity of computer technology, the plug and play function becomes an essential function of computer peripheral equipment. As to a display device, the video electronics standard association (VESA) is responsible for promoting and developing important display device and display device interface standards, so as to make sure its commonality. Extended display identification data (EDID) standard is one of the standard data formats established by VESA. EDID includes basic data of a display, such as: manufacturer information, maximum image size, color feature, usage frequency limitation, and etc. The EDID is stored in a display device and used for communicating with a computer host, thereby achieving the plug and play function.

In the past decades, as shown in FIG. 1, display device manufacturers always directly store EDID corresponding to a plurality of different type displays of device into storage medium such as a hard drive 931 by means of outright-purchase, and connect to a PC frame 93 to form a computer 930 as a main frame for an EDID burning operation, so as to respectively connect to a VGA interface 911, a DVI interface 912 or a HDMI interface 913 of a display device 91 via a transmission line 94 and an interface converting device 95, thereby writing the EDID into its non-erasable memory. That is, if it is going to perform a burning operation to an A-47 type display device, but the EDID of the A-47 type display device to be burned is stored in the hard drive 931, the manufacturing operator has to utilize a barcode scanner 92 and the computer 930 to read the EDID from the floppy 931, and then write the EDID into the display device via a VGA interface.

However, in the past, operations of downloading, editing and burning in the EDID were all executed on the basis of the PC frame 93 for directly loading the data into the storage medium, which leads to a lot of shortcomings, for example: (1) no registration and authorization functions; (2) unable to charge the display device manufacturers (users) by times because the EDID is sold by means of outright-sell; (3) unable to perform a synchronous updating or sharing procedure because each EDID independently exists, which is not ideal for use.

Therefore, it is desirable to provide a register authorization system and its method of downloading extended display identification data to mitigate and/or obviate the aforementioned problems.

### SUMMARY OF THE INVENTION

In order to solve the abovementioned problems, the present invention provides a register authorization system of downloading extended display identification data (EDID), which comprises: a parent system unit, stored with a plurality of EDID and used for accepting a logon and registration request; and a sub system unit, coupled to the parent system unit, after the parent system unit accepts the logon and registration request, and a data transmission procedure between the sub system unit and the parent system unit is authenticated and protected under a specific algorithm, the sub system unit then obtaining an authentication and authorization instruction from the parent system unit to execute an EDID download program. Therefore, one objective of the present invention is to provide a register authorization system of downloading extended display identification data, so as to execute the EDID download program based on its registration and authorization function. Further, another objective of the present invention is to provide an authentication procedure as a protection of the register authorization system and data, including the authentication processes of protecting user identification codes, consumer system data, downloaded EDID data encryption process or uploaded data in an EDID burning device.

According to the above description, in the register authorization system of downloading extended display identification data of the present invention, the sub system unit comprises at least one EDID burning device, which has an identification code registered in the parent system unit, and the identification code is respectively stored in both the at least one EDID burning device and the parent system unit, so as to obtain the authentication and authorization instruction from the parent system unit to execute the EDID download program. The identification code is preferably generated by the parent system unit by means of a random number algorithm, or could be chosen by a user.

According to the above description, in the register authorization system of downloading extended display identification data of the present invention, the parent system unit comprises a network management server, which is stored with the identification code and is connected to the at least one EDID burning device via a connection, such that the network management server could obtain the identification code from the at least one EDID burning device, and then execute an authentication and authorization program. The above connection comprises a network and at least one EDID management server, wherein the at least one EDID management server has EDID, and could obtain the identification code from the at least one EDID burning device by means of an EDID upload/download program, thereby uploading the identification code to the network management server via the network.

According to the above description, in the register authorization system of downloading extended display identification data of the present invention, the specific algorithms preferably comprise a hash algorithm, an encryption algorithm and a decryption algorithm, or other equivalent algorithms.

According to the above description, in the register authorization system of downloading extended display identification data of the present invention, the network management server further comprises a first confidential data.

According to the above description, in the register authorization system of downloading extended display identification data of the present invention, after the at least one EDID burning device obtains the authorization instruction from the network management server, the network management server transmits a first hash algorithm operational result to the at least one EDID management server, wherein the first hash algorithm operational result is obtained by applying the hash algorithm to the identification code and the first confidential data.

According to the above description, in the register authorization system of downloading extended display identification data of the present invention, the at least one EDID management server and the at least one EDID burning device respectively have a second confidential data.

According to the above description, in the register authorization system of downloading extended display identification data of the present invention, the at least one EDID management server transmits an EDID encryption result along with a first hash algorithm operational result to the at least one EDID burning device for executing the EDID download program, wherein the EDID encryption result is obtained by applying the encryption algorithm to the EDID and the second confidential data.

According to the above description, in the register authorization system of downloading extended display identification data of the present invention, the at least one EDID burning device decrypts the EDID by applying the decryption algorithm to the EDID encryption result and the second confidential data, so as to successfully perform a burning operation.

According to the above description, in the register authorization system of downloading extended display identification data of the present invention, after the at least one EDID burning device performs the burning operation, counter data would be generated representing an accumulated performing time of the burning operation.

According to the above description, in the register authorization system of downloading extended display identification data of the present invention, the at least one EDID burning device obtains a second hash algorithm operational result by applying the hash algorithm to the counter data and the first hash algorithm operational result, such that the network management server, by means of the at least one EDID management server, could obtain the identification code along with the second hash algorithm operational result and the counter data from the at least one EDID burning device via the EDID upload/download program, and execute a next time authentication and authorization program and payment management.

The present invention also provides a method used in a register authorization system of downloading extended display identification data (EDID). The method comprises the steps of: (A) the EDID management server obtaining an identification code from the EDID burning device, and uploading the identification code to the network management server via the network for executing an authentication and authorization program; (B) when the EDID burning device obtaining an authorization instruction from the network management server, the network management server transmitting a first hash algorithm operational result to the EDID management server, wherein the first hash algorithm operational result is obtained by applying a hash algorithm to the identification and a first confidential data; (C) the EDID management server transmitting an EDID encryption result along with the first hash algorithm operational result to the EDID burning device for executing an EDID download program, wherein the EDID encryption result is obtained by applying an encryption algorithm to the EDID the a second confidential data; and (D) the EDID burning device obtaining an EDID decryption result by applying a decryption algorithm to decrypt the EDID encryption result and the second confidential data, so as to perform a burning operation to a display device.

According to the above description, the method used in a register authorization system of downloading extended display identification data of the present invention further comprises the steps of: (E) after the EDID burning device performing the burning operation, generating counter data representing an accumulated performing time of the burning operation; and (F) the network management server, by means of the EDID management server, obtaining the identification code along with the second hash algorithm operational result and the counter data from the EDID burning device, so as to execute a next time authentication and authorization program and payment management, wherein the second hash algorithm operational result is obtained by applying a hash algorithm to the counter data and the first hash algorithm operational result by the EDID burning device.

### BRIEF DESCRIPTION OF THE DRAWINGS

FIG. 1 illustrates a conventional system schematic drawing.

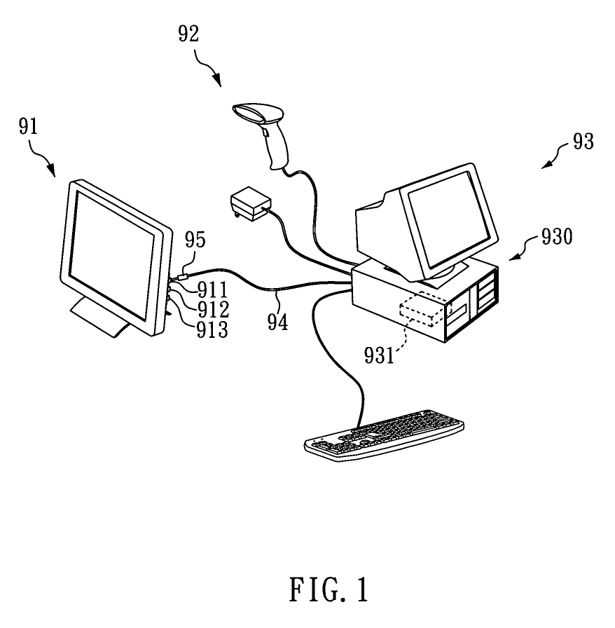

FIG. 2 illustrates a block diagram of a register authorization system of downloading extended display identification data of one preferred embodiment according to the present invention.

FIGS. 3˜6 illustrate schematic drawings of register authorization procedures of downloading extended display identification data of one preferred embodiment according to the present invention.

FIG. 7 illustrates a flow of a new customer service provided by a network management server.

FIG. 8 illustrates a flow of a payment and account value-added service provided by the network management server.

FIG. 9 illustrates a flow of a software using situation and feedback service provided by the network management server.

FIG. 10 illustrates a flow of a customer opinion or complaint processing service provided by the network management server.

### DETAILED DESCRIPTION OF THE PREFERRED EMBODIMENT

Below please find specific embodiments to explain the implementation of the present invention, such that a person skilled in the art could easily understand the advantage and effect of the present invention according to the disclosure of this specification.

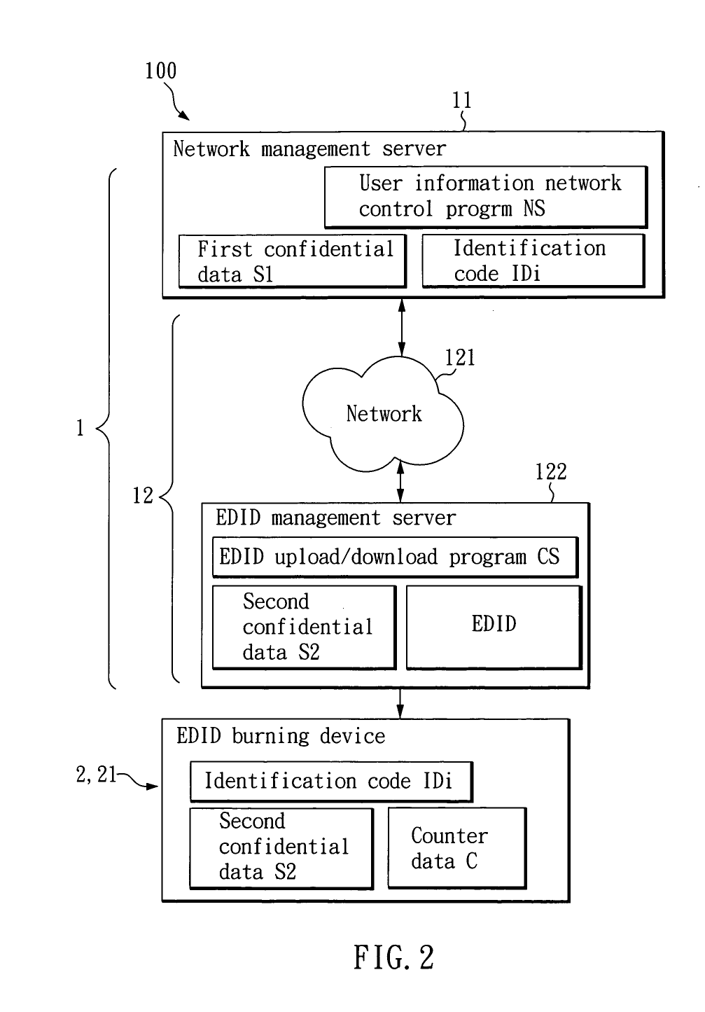

Please refer to FIG. 2, which illustrates a block diagram of a register authorization system of downloading extended display identification data (EDID) of one preferred embodiment according to the present invention. As shown in FIG. 2, the register authorization system 100 of downloading extended display identification data of the present invention comprises a sub system unit 2 and a parent system unit 1.

The sub system unit 2 is coupled to the parent system unit 1. After the parent system unit 1 accepts a logon and registration request, and a data transmission procedure between the sub system unit 2 and the parent system unit 1 is authenticated and protected under a specific algorithm, the sub system unit 2 could then obtain an authentication and authorization instruction from the parent system unit 1 to execute an EDID download program. In this embodiment, the specific algorithms comprise a hash algorithm, an encryption algorithm and a decryption algorithm. Wherein, a message-digestion algorithm 5 (MD5) is a one-way hash algorithm as well as an algorithm which is difficult to obtain original data by means of any inverse operation, and is used for checking if whether a user identification code is valid. The encryption algorithm is one kind of symmetric algorithms, and is used for encrypting protected data. Further, the sub system unit 2 is an EDID burning device 21, which has a second confidential data S2 and counter data C, and could logon and register an identification code IDi into the parent system unit 1, wherein the identification code IDi is respectively stored in both the EDID burning device 21 and the parent system unit 1, so as to obtain the authentication and authorization instruction from the parent system unit 1 to execute the EDID download program. Please note that the above identification code IDi is generated by the parent system unit 1 by means of a random number algorithm, or could be chosen by a user, either way is unique. Therefore, the register authorization system 100 of downloading extended display identification data of the present invention could detect a multiple-login identification code, and immediately delete it to terminate the right of downloading EDID. Moreover, if a user performs the authentication and authorization procedure and downloads the EDID at a previous time in one place (for example: Taiwan), and then performs the authentication and authorization procedure and downloads the EDID a within a short period of time (for example: half an hour later) in another place (for example: the United States), the register authorization system 100 of downloading extended display identification data of the present invention would also immediately terminate the right of downloading EDID.

The parent system unit 1 comprises a network management server 11, which is used for executing a user information network control program NS, has a first confidential data S1, stores the above identification code IDi, and could connect to the EDID burning device 21 via a connection 12. In this embodiment, the connection 12 comprises a network 121 and an EDID management server 122. The EDID management server 122 comprises EDID and a second confidential data S2, and could obtain the identification code IDi from the EDID burning device 21 by means of an EDID upload/download program CS, thereby uploading the identification code IDi to the network management server 11 via the network 121, such that the network management server 11 could obtain the identification code IDi from the EDID burning device 21 and then execute the authentication and authorization program.

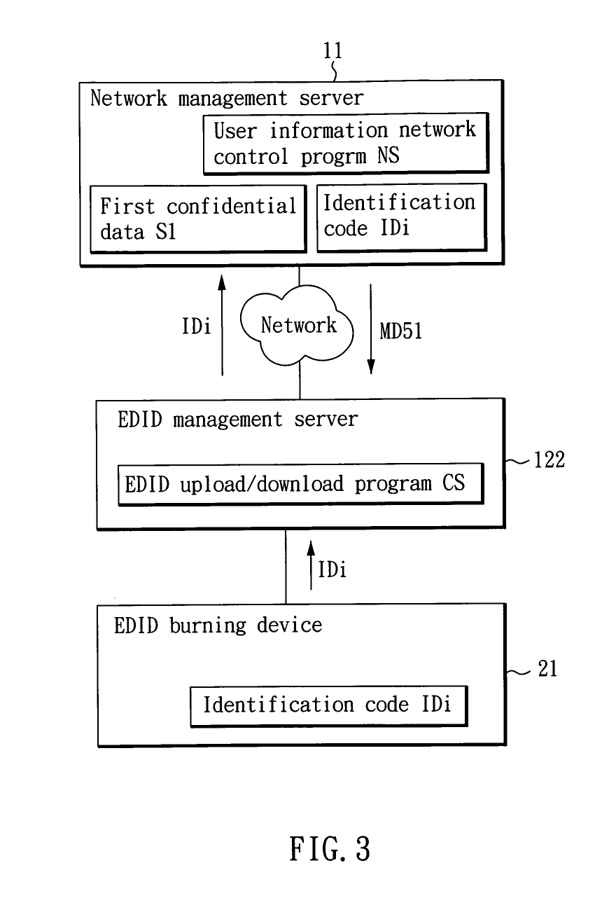

Please refer to FIGS. 3˜6. In this embodiment, the EDID management server 122 obtains the identification code IDi from the EDID burning device 21 by means of the EDID upload/download program CS, thereby uploading the identification code IDi to the network management server 11 via the network 121 for executing the authentication and authorization program (please refer to FIG. 3).

After the EDID burning device 21 obtains the authorization instruction from the network management server 11, the network management server 11 transmits a first hash algorithm operational result MD51 to the EDID management server 122, wherein the first hash algorithm operational result MD51 is obtained by applying the hash algorithm to the identification code IDi and the first confidential data S1.

Next (please refer to FIG. 4), the EDID management server 122 transmits an EDID encryption result RC2e along with the first hash algorithm operational result MD51 to the EDID burning device 21 for executing the EDID download program, wherein the EDID encryption result is obtained by applying the encryption algorithm to the EDID and the second confidential data S2.

After completing the EDID download program (please refer to FIG. 5), the EDID burning device 21 is not required to be connected to the EDID management server 122, and could directly perform the burning operation to the display device 200. However, when the EDID burning device 21 is going to perform the burning operation, at first the EDID encryption result RC2e and the second confidential data S2 has to be decrypted by applying the decryption algorithm to obtain an EDID decryption result RC2d, and then the burning operation could be successfully performed. Please note that (please refer to FIG. 6) after the EDID burning device 21 performs the burning operation, counter data C would be generated representing an accumulated performing time of the burning operation. Such that the network management server 11, by means of the EDID management server 122, could obtain the identification code IDi along with a second hash algorithm operational result MD52 and the counter data C from the EDID burning device 21 via the EDID upload/download program CS, and execute a next time authentication and authorization program and payment management. The above second hash algorithm operational result MD52 is obtained by applying the hash algorithm to the counter data and the first hash algorithm operational result MD51. Further, the counter data representing the accumulated performing time of the burning operation could be provided to the register authorization system 100 of downloading extended display identification data for tracking the burning time of the EDID burning device 21, for remotely controlling and processing the counter data, and also for counting the total amount and then charging a system service and maintenance fee from the user.

Further, please note that in this embodiment, the network management server 11, by means of the EDID management server 122, could obtain the identification code IDi along with the second hash algorithm operational result MD52 and the counter data C from the EDID burning device 21 via the EDID upload/download program CS, and execute a next time authentication and authorization program and payment management. If the connection is failed or the authentication procedure is failed, the EDID upload/download program CS would not be able to work, that is, the user would not be able to download the EDID.

According to the above description, the present invention provides a register authorization system 100 of downloading extended display identification data, so as to execute the EDID download program based on its registration and authorization function. Further, since EDID is not sold by means of outright-sell, the user would be charged based on the burning time, thereby achieving a reasonable user-charge payment mechanism. Moreover, the present invention implements an authentication procedure to replace the protection of the system and data, so as to protect user identification codes, consumer system data, downloaded EDID data encryption process or uploaded data in the EDID burning device.

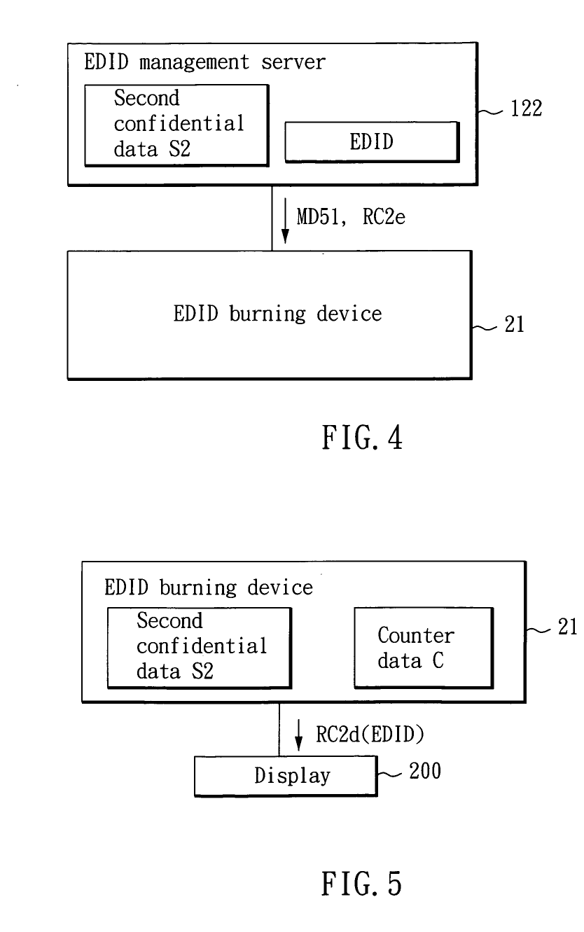

Further, the network management server 11 of the present invention could further provide a new customer service, a payment and account value-added service, a software using situation and feedback service, and a customer opinion or complaint processing service. For example, FIG. 7 illustrates a flow of the new customer service provided by the network management server 11. The system administrator and the account system are included in the network management server 11, and the customer user is the EDID management server 122. A new customer user notifies the system administrator by means of a new customer mechanism through a market channel, such as the Internet or facsimile. Then, the system administrator would register this new customer into the account system, send a notification mail and provide a download software program to the customer user, and deliver goods, i.e. the EDID burning device, to the customer user via a delivery service provider.

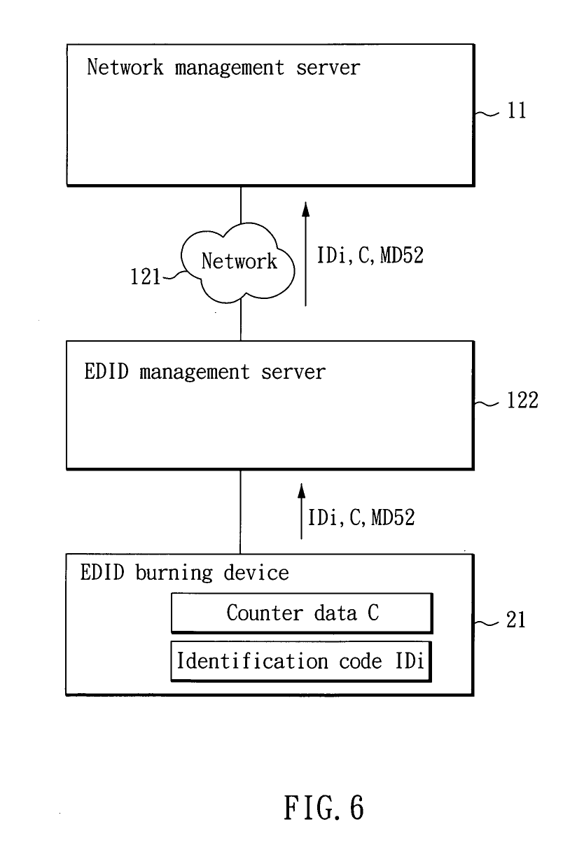

FIG. 8 illustrates a flow of the payment and account value-added service provided by the network management server 11. The system administrator and the account system are included in the network management server 11, and the customer user is the EDID management server 122. The customer user utilizes a payment mechanism, such as on-line wire transfer, credit card payment or postal transfer, to pay a system authorization (usage) fee to the bank administrator. The bank administrator would then notify the system administrator about a corresponding receipt. After the system administrator receives the notification, it would add usable points of this customer user in the account system, and sends a notification mail to inform the customer user.

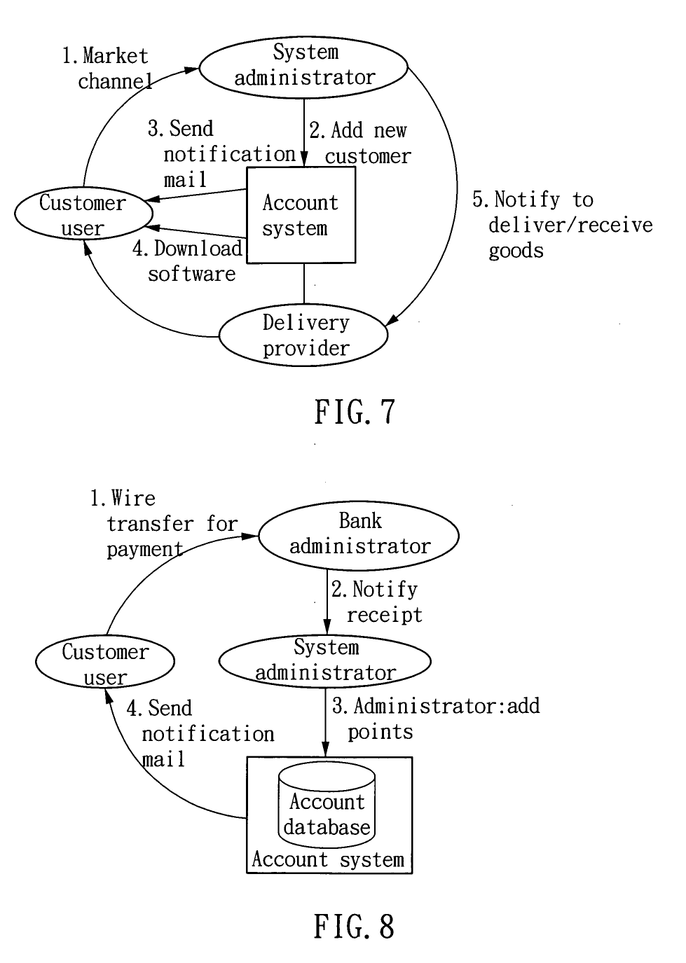

FIG. 9 illustrates a flow of the software using situation and feedback service provided by the network management server 11. The system administrator and the account system are included in the network management server 11, and the customer user is the EDID management server 122. After the customer user uses the software and the EDID burning device to perform the EDID burning operation to the display device, a using situation would be immediately returned to the account system of the network management server 11, such that the account system could adjust the usable points of the customer user accordingly. When the usable point in the account system turns to 0, a shutdown signal code would be sent to the EDID burning device to shut down the EDID burning device.

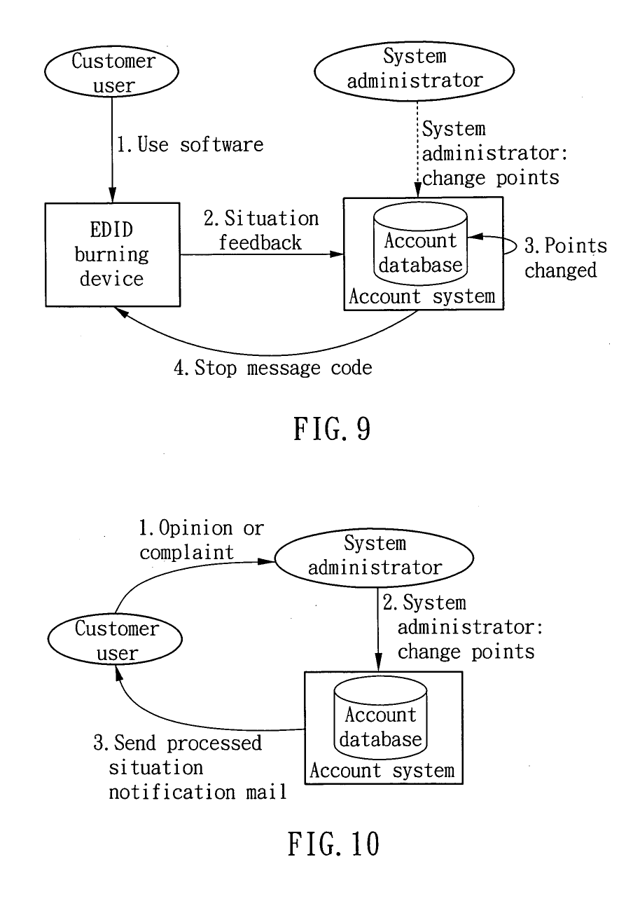

FIG. 10 illustrates a flow of the customer opinion or complaint processing service provided by the network management server 11. The system administrator and the account system are included in the network management server 11, and the customer user is the EDID management server 122. The customer user could provide an opinion or complaint to the system administrator. The system administrator would change usable points in the account system accordingly. And the account system would send a processing situation notification mail to the customer user to inform about the processing situation.

Although the present invention has been explained in relation to its preferred embodiment, it is to be understood that many other possible modifications and variations can be made without departing from the spirit and scope of the invention as hereinafter claimed.

What is claimed is:

1. A register authorization system of downloading extended display identification data (EDID), comprising:
a parent system unit, stored with a plurality of EDID and used for accepting a logon and registration request; and
a sub system unit, coupled to the parent system unit, after the parent system unit accepts the logon and registration request, and a data transmission procedure between the sub system unit and the parent system unit is authenticated and protected under a specific algorithm, the sub system unit then obtaining an authentication and authorization instruction from the parent system unit to execute an EDID download program.

2. The system as claimed in claim 1, wherein the sub system unit comprises at least one EDID burning device, which has an identification code registered in the parent system unit, and the identification code is respectively stored in both the at least one EDID burning device and the parent system unit, so as to obtain the authentication and authorization instruction from the parent system unit to execute the EDID download program.

3. The system as claimed in claim 2, wherein the identification code is generated by the parent system unit by means of a random number algorithm.

4. The system as claimed in claim 2, wherein the parent system unit comprises a network management server, which is connected to the at least one EDID burning device via a connection, such that the network management server could obtain the identification code from the at least one EDID burning device, and then execute an authentication and authorization program.

5. The system as claimed in claim 4, wherein the connection comprises a network and at least one EDID management server, the at least one EDID management server has EDID, and could obtain the identification code from the at least one EDID burning device by means of an EDID upload/download program, thereby uploading the identification code to the network management server via the network.

6. The system as claimed in claim 1, wherein the specific algorithm comprises a hash algorithm.

7. The system as claimed in claim 4, wherein the network management server further comprises a first confidential data.

8. The system as claimed in claim 7, wherein after the at least one EDID burning device obtains the authorization instruction from the network management server, the network management server transmits a first hash algorithm operational result to the at least one EDID management server, wherein the first hash algorithm operational result is obtained by applying the hash algorithm to the identification code and the first confidential data.

9. The system as claimed in claim 8, wherein the specific algorithm further comprises an encryption algorithm and a decryption algorithm.

10. The system as claimed in claim 9, wherein the at least one EDID management server and the at least one EDID burning device respectively have a second confidential data.

11. The system as claimed in claim 10, wherein the at least one EDID management server transmits an EDID encryption result along with the first hash algorithm operational result to the at least one EDID burning device for executing the EDID download program, wherein the EDID encryption result is obtained by applying the encryption algorithm to the EDID and the second confidential data.

12. The system as claimed in claim 11, wherein the at least one EDID burning device decrypts the EDID by applying the decryption algorithm to the EDID encryption result and the second confidential data, so as to successfully perform a burning operation.

13. The system as claimed in claim 12, wherein after the at least one EDID burning device performs the burning operation, counter data would be generated representing an accumulated performing time of the burning operation.

14. The system as claimed in claim 13, wherein the at least one EDID burning device obtains a second hash algorithm operational result by applying a hash algorithm to the counter data and the first hash algorithm operational result, such that the network management server, by means of the at least one EDID management server, could obtain the identification code along with the second hash algorithm operational result and the counter data from the at least one EDID burning device via the EDID upload/download program, and execute a next time authentication and authorization program and payment management.

15. A method used in a register authorization system of downloading extended display identification data (EDID), the system comprising a network management server, at least one EDID management server and at least one EDID burning device, the at least one EDID management server connected to the network management server via a network, the method comprising the steps of:
(A) the EDID management server obtaining an identification code from the EDID burning device, and uploading the identification code to the network management server via the network for executing an authentication and authorization program;
(B) when the EDID burning device obtains an authorization instruction from the network management, the network management server transmitting a first hash algorithm operational result to the EDID management server, wherein the first hash algorithm operational result is obtained by applying a hash algorithm to the identification code and a first confidential data;
(C) the EDID management server transmitting an EDID encryption result along with the first hash algorithm operational result to the EDID burning device for executing an EDID download program, wherein the EDID encryption result is obtained by applying an encryption algorithm to the EDID the a second confidential data; and
(D) the EDID burning device obtaining an EDID decryption result by applying a decryption algorithm to decrypt the EDID encryption result and the second confidential data, so as to perform a burning operation to a display device.

16. The method as claimed in claim 15, further comprising the steps of:
(E) after the EDID burning device performs the burning operation, generating counter data representing an accumulated performing time of the burning operation; and
(F) the network management server, by means of the EDID management server, obtaining the identification code along with the second hash algorithm operational result and the counter data from the EDID burning device, so as to execute a next time authentication and authorization program and payment management, wherein the second hash algorithm operational result is obtained by applying a hash algorithm to the counter data and the first hash algorithm operational result by the EDID burning device.

17. The method as claimed in claim 16, further comprising the step of:
(G) the network management server receiving a notification of a new customer, registering the new customer into an account system, and sending a notification mail and providing a download software program to the new customer.

18. The method as claimed in claim 16, further comprising the step of:
(H) the network management server receiving a notification of a customer user payment, and adding usable points of the customer user in an account system.

19. The method as claimed in claim 16, further comprising the step of:
(I) the network management server receiving a feedback after a customer user uses the EDID burning device to perform the EDID burning operation to the display device, and adjusting usable points of the customer user in an account system, when the usable point in the account system turns to 0, sending a shutdown signal code to the EDID burning device to shut down the EDID burning device.

20. The method as claimed in claim 16, further comprising the step of:
(J) the network management server receiving an opinion or complaint from a customer user, and changing usable points of the customer user in an account system accordingly.
